(19) United States
(12) Patent Application Publication
(10) Pub. No.: US 2026/0178231 A1
(43) Pub. Date: Jun. 25, 2026

(54) INTERLEAVED SEQUENTIAL READ OPERATIONS FOR MEMORY SYSTEMS

(71) Applicant: Micron Technology, Inc., Boise, ID (US)

(72) Inventors: Chaohui Liu, Shanghai (CN); Ming Ma, Shanghai (CN)

(21) Appl. No.: 19/410,900

(22) Filed: Dec. 5, 2025

Related U.S. Application Data
(60) Provisional application No. 63/738,427, filed on Dec. 23, 2024.

(51) Int. Cl. G06F 3/06

(52) U.S. Cl. CPC G06F 3/0659; G06F 3/0604; G06F 3/0679

(57) ABSTRACT

Methods, systems, and devices for interleaved sequential read operations for memory systems are described. For example, a memory system may maintain multiple read caches, each associated with a corresponding sequential data stream. Each cache may be associated with a pre-read window of data that is ready to be read into the cache. In some examples, in response to receiving a first read command associated with data of a first sequential data stream, the memory system may store data in a first cache. In response to receiving a second read command associated with data of a second sequential data stream (e.g., concurrent with the first sequential data stream), the memory system may store data in a second cache. The memory system may accordingly store data of multiple sequential data streams in multiple caches.

### CROSS REFERENCE

The present Application for Patent claims priority to U.S. Provisional Patent Application No. 63/738,427 by Liu et al., entitled “INTERLEAVED SEQUENTIAL READ OPERATIONS FOR MEMORY SYSTEMS,” filed Dec. 23, 2024, which is assigned to the assignee hereof, and which is expressly incorporated by reference in its entirety herein.

### TECHNICAL FIELD

The following relates to one or more systems for memory, including interleaved sequential read operations for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not- or (NOR) and not- and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports interleaved sequential read operations for memory systems in accordance with examples as disclosed herein.

FIG. 2 shows an example of a cache implementation that supports interleaved sequential read operations for memory systems in accordance with examples as disclosed herein.

FIG. 3 shows an example of a process that supports interleaved sequential read operations for memory systems in accordance with examples as disclosed herein.

FIG. 4 shows a block diagram of a memory system that supports interleaved sequential read operations for memory systems in accordance with examples as disclosed herein.

FIG. 5 shows a flowchart illustrating a method or methods that support interleaved sequential read operations for memory systems in accordance with examples as disclosed herein.

### DETAILED DESCRIPTION

A host system may operate in a sequential mode in which multiple processes (e.g., multiple threads) may be performing sequential read requests to read data from a memory system (e.g., a universal flash storage (UFS) device, a managed NAND device). However, the memory system may receive the sequential read requests for multiple ranges of logical block addresses (LBAs) during an overlapping interval, and may therefore interpret the read requests as random read requests (e.g., unrelated requests) rather than multiple sequential reads. The memory system may therefore not maintain a pre-read window of data that is ready to be output to the host system, which may not effectively leverage a read cache of the memory system in some situations.

In accordance with techniques as disclosed herein, a memory system may be configured to store data in multiple caches (e.g., multiple read caches, multiple pre-read entries), each associated with a respective sequential data stream. Each cache may be associated with a pre-read window of data that is ready to be read into the cache (e.g., from one or more memory devices), and the memory system may increase the size of the pre-read window if an LBA of a read command satisfies an LBA threshold. In some examples, in response to receiving a read command associated with an LBA that is outside of a currently active cache (e.g., a read cache that is storing data), the memory system may store data in a new cache without emptying the currently active cache. A memory system may accordingly maintain multiple caches corresponding to multiple concurrent sequential data streams. In some examples (e.g., if no caches are empty), a memory system may empty a currently active cache for which the memory system has received less than a threshold quantity of read commands. A memory system may, in some examples, reset all caches in response to receiving a threshold quantity of commands that do not trigger the memory system to populate a new cache.

In addition to applicability in memory systems as described herein, techniques for interleaving sequential read operations may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing usage to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling a memory system to support simultaneous sequential read operations, which may decrease processing or latency times, improve response times, or otherwise improve user experience, among other benefits.

Features of the disclosure are illustrated and described in the context of systems, devices, and circuits. Features of the disclosure are further illustrated and described in the context of cache implementations, processes, and flowcharts.

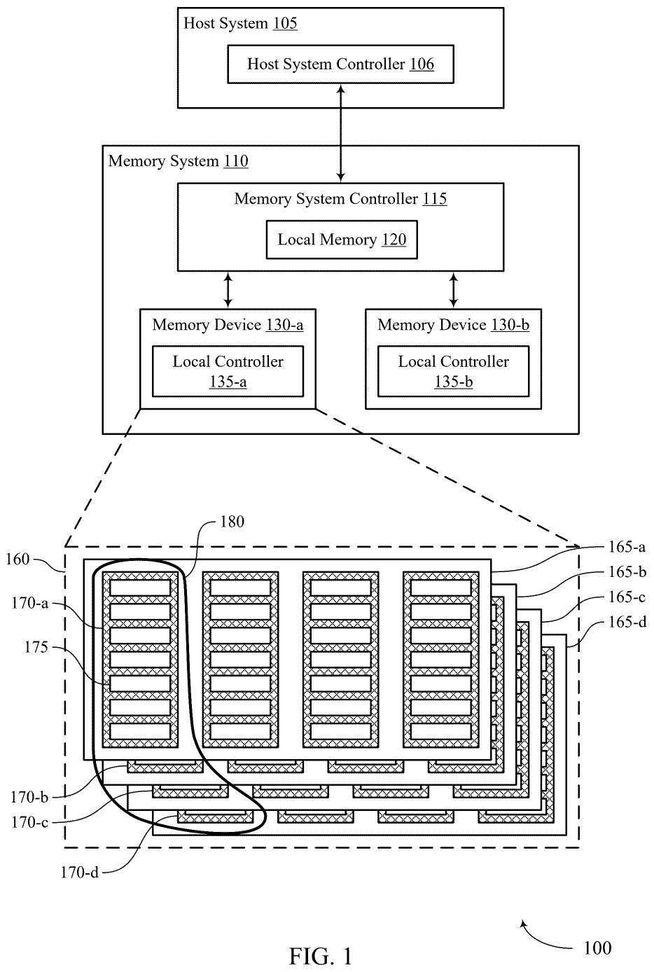

FIG. 1 shows an example of a system 100 that supports interleaved sequential read operations for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130-among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In accordance with examples as disclosed herein, one or more components of a memory system 110 (e.g., a memory system controller 115, one or more local controllers 135, or a combination thereof) may be configured to store data in multiple caches (e.g., multiple read caches, multiple pre-read entries, of local memory 120), each associated with a respective sequential data stream (e.g., as requested by a host system 105, in accordance with one or more processes of the host system 105). Each cache may be associated with a pre-read window of data that is ready to be read into the cache (e.g., from one or more memory devices 130), and a memory system 110 may increase the size of the pre-read window if an LBA of a read command satisfies an LBA threshold. In some examples, in response to receiving a read command associated with an LBA that is outside of LBAs stored in a currently active cache (e.g., a current pre-read entry that is not in a reset state), a memory system 110 may store data in a new cache associated with the read command without emptying the currently active cache. A memory system 110 may accordingly store data from multiple concurrent sequential data streams in multiple caches simultaneously. In some examples (e.g., if no caches are empty), a memory system 110 may reset a currently active cache for which the memory system 110 has received less than a threshold quantity of read commands. A memory system 110 may also reset all caches in response to receiving a threshold quantity of commands that do not trigger the memory system 110 to populate a new cache.

The system 100 may include any quantity of non-transitory computer readable media that support interleaved sequential read operations for memory systems. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

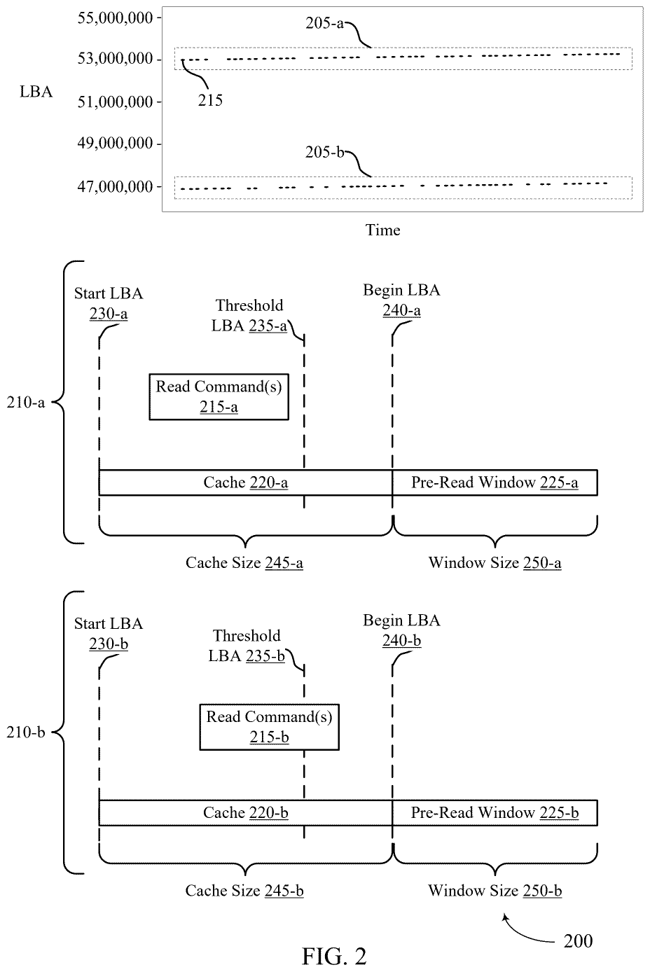

FIG. 2 shows an example of a cache implementation 200 that supports interleaved sequential read operations for memory systems in accordance with examples as disclosed herein. The cache implementation 200 may implement or may be implemented by aspects of a system 100. For example, the cache implementation 200 may be implemented by a memory system 110 (e.g., a memory system controller 115 coupled with one or more memory devices 130), which may store data accessible to a host system 105 that is coupled with the memory system 110.

A memory system 110 (e.g., one or more components of a memory system 110 such as a memory system controller 115, one or more local controllers 135, or a combination thereof) may receive read commands 215 (e.g., from a host system 105) that are associated with sequential streams 205 (e.g., streams of sequential data). In some examples, a sequential stream 205 may refer to data that is associated with sequential LBAs, or otherwise related LBAs (e.g., LBAs associated with sequential data, LBAs associated with sequentially-accessed data). When outputting data of a sequential stream 205, firmware of a memory system 110 may be configured to trigger a pre-read policy to increase read performance (e.g., to decrease a latency of responses to read commands, to increase read operation throughput) of the memory system 110 (e.g., in a sequential mode of operation). For example, a memory system 110 may store data associated with a sequential stream 205 in a cache 220 (e.g., a pre-read cache, a data ready cache, a cache of a memory system controller 115, a cache of local memory 120), and the memory system 110 may output the data to the host system 105. In some examples, a cache 220 may be associated with a pre-read window 225, which may refer to data (e.g., of LBAs associated with a sequential stream 205) that the memory system 110 is prepared to store in the cache 220.

In some examples, however, a memory system 110 may receive read commands 215 for multiple different sequential streams 205 concurrently (e.g., one or more read commands 215-a for data of a sequential stream 205-a that are overlapping in time with one or more read commands 215-b for data of a sequential stream 205-b). For example, a memory system 110 may receive a read command 215 for a first set of data in the sequential stream 205-a, followed by a read command 215 for a second set of data in the sequential stream 205-b, followed by a read command 215 for a third set of data in the sequential stream 205-a, and so on (e.g., in an interleaved manner). In illustrative examples of such conditions, a host system 105 may use multiple threads that may perform sequential reads concurrently, or a memory system 110 may receive commands from multiple host systems 105, among other examples. In some such examples, a memory system 110 may interpret interleaved read commands as being for random data (e.g., rather than data of the sequential streams 205-a and 205-b), and therefore may refrain from using the pre-read policy, which may result in decreased performance (e.g., increased latency) associated with the sequential reads.

In accordance with techniques as disclosed herein, a memory system 110 may be configured to store data of multiple sequential streams 205 in a respective cache 220 (e.g., a cache 220-a associated with a sequential stream 205-a and a cache 220-b associated with a sequential stream 205-b). Such a memory system 110 may therefore use a pre-read policy for multiple concurrent sequential streams 205 (e.g., sequential streams 205 for which the memory system 110 receives read commands in an interleaved manner), which may result in improved performance of the memory system 110.

In some examples, a memory system 110 may be configured to manage multiple pre-read state entries 210 associated with multiple caches 220, which the memory system 110 may use to track multiple sequential data streams 205. For example, as illustrated with reference to Table 1, each pre-read state entry 210 (e.g., State Entry A, State Entry B) may include one or more parameters, including an indication of a start LBA 230 of the cache 220, a cache size 245 (e.g., a quantity of LBAs of the cache 220), a threshold LBA 235 (e.g., indLBA), a hit count (e.g., a counter that tracks a quantity of read commands 215 for data that is part of the sequential stream 205), a begin LBA 240 (e.g., a beginning of a pre-read window 225), and/or a window size 250 of the pre-read window 225 (e.g., nCnt, a quantity of LBAs in the pre-read window 225). Although the example of Table 1 illustrates an implementation of two state entries 210 (e.g., corresponding to two caches 220 that may be managed concurrently), the described techniques may be implemented with any quantity of state entries 210.

TABLE 1

| | | | | | |
|---|---|---|---|---|---|
| | Cache | Threshold | Hit | Begin | Window |
| Start LBA | Size | LBA | Count | LBA | Size |

State Entry A
State Entry B

In some examples, if a memory system 110 has not received any read commands 215 (e.g., any sequential read commands, any read commands for a sequential stream 205, within a threshold duration), each state entry 210 may be in a reset state. That is, the memory system 110 may set each parameter in each state entry 210 to 0, or otherwise reset or initialize state entries 210, and may not store any data in one or more caches 220. In response to receiving a first read command (e.g., a read command 215-a from a host system 105, corresponding to the sequential stream 205-a), the memory system 110 may set (e.g., populate) a state entry 210-a in accordance with the read command 215-a. For example, the memory system 110 (e.g., a memory system controller 115) may store data associated with the read command 215-a (e.g., as read from one or more memory devices 130) in a cache 220-a associated with the state entry 210-a. The memory system may set a start LBA 230-a of the cache 220-a to a first LBA of the read command 215-a (e.g., a host read start LBA), and may set the cache size 245-a of the cache 220-a, a threshold LBA 235-a, a begin LBA 240-a, and a window size 250-a of a pre-read window 225-a based on a quantity of data (e.g., a quantity of LBAs) requested via the read command 215-a and/or to one or more pre-configured values. For example, the memory system 110 may set the size of the pre-read window 225-a to two times a chunk size associated with the read command 215-a.

The memory system 110 may output the data requested by the read command 215-a (e.g., data transferred to and stored in the cache 220-a) to the host system 105 in accordance with the read command 215-a. The memory system 110 may update the cache 220-a based on outputting the data. That is, the memory system 110 may update values of the start LBA 230-a, the cache size 245-a of the cache 220-a, the threshold LBA 235-a, the begin LBA 240-a, and/or the window size 250-a of the pre-read window 225-a. For example, the memory system 110 may store data from the pre-read window 225-a in the cache 220-a, and may load additional data to the pre-read window 225-a by attempting a pre-read request for the additional data (e.g., from the begin LBA 240-a to the begin LBA 240-a plus the window size 250-a, from one or more memory devices 130) to be loaded into the pre-read window 225-a.

In some examples, the memory system 110 may determine whether a read command 215 is for a sequential stream 205. For example, the memory system 110 may receive an indication from a host system 105 that the read command 215 is for a sequential stream 205. In such examples, the memory system may set a state entry 210 and store data in a cache 220 in response to determining that the read command 215 is for a sequential stream 205.

Additionally, or alternatively, the memory system may maintain a counter (e.g., a hit counter, hitCnt) for each state entry 210 (e.g., for each cache 220) that may track a quantity of read commands 215 for data that is stored in the corresponding cache 220. For example, if the memory system 110 receives a read command 215-a for data stored in the cache 220-a (e.g., if a first LBA of data requested by the read command 215-a is greater than a start LBA 230-a of the cache 220-a and less than a begin LBA 240-a of a pre-read window 225-a), the memory system 110 may increment a counter associated with the cache 220-a. The memory system 110 may determine that the cache 220-a is associated with a potential sequential stream 205 if the counter associated with the cache 220-a is below a threshold (e.g., a hit threshold, such as 6 read commands 215 that fall within the cache 220-a), or that the cache 220-a is associated with a sequential stream 205 if the counter associated with the cache 220-a satisfies the threshold.

In some examples, if the memory system 110 has a second state entry (e.g., a state entry 210-b) that is in a reset state (e.g., associated with an empty cache 220-b and with parameters set to 0), the memory system 110 may set the state entry 210-b as described herein and store data in the cache 220-b in response to receiving a read command 215-b (e.g., for data of a sequential stream 205-b) that does not fall within the cache 220-a. That is, the memory system 110 may store data associated with the read command 215-b in the cache 220-b associated with the state entry 210-b. The memory system 110 may set a start LBA 230-b of the cache 220-b to a first LBA of the read command 215-b (e.g., a host read start LBA), and may set the cache size 245-b of the cache 220-b, a threshold LBA 235-b, a begin LBA 240-b, and a window size 250-b of a pre-read window 225-b based on a quantity of data (e.g., a quantity of LBAs) requested via the read command 215-b and/or to one or more pre-configured values. For example, the memory system 110 may set the window size 250-b of the pre-read window 225-b to two times a chunk size associated with the read command 215-b.

The memory system 110 may output the data requested by the read command 215-b (e.g., data transferred to and stored in the cache 220-b) to the host system 105 in accordance with the read command 215-b. The memory system 110 may update the cache 220-b based on outputting the data. That is, the memory system 110 may update values of the start LBA 230-b, the cache size 245-b of the cache 220-b, the threshold LBA 235-b, the begin LBA 240-b, and/or the window size 250-b of the pre-read window 225-b. For example, the memory system 110 may store data from the pre-read window 225-b in the cache 220-b, and may load additional data to the pre-read window 225-b by attempting a pre-read request for the additional data (e.g., from the begin LBA 240-b to the begin LBA 240-b plus the window size 250-b, from one or more memory devices 130) to be loaded into the pre-read window 225-b.

Accordingly, the memory system 110 may maintain multiple state entries 210 and store data in multiple caches 220 (e.g., caches 220 each corresponding to a respective sequential stream 205) concurrently. The memory system 110 may therefore receive read commands 215 for each sequential stream 205, store data in each cache 220, and output the requested data in accordance with the read commands 215 in an interleaved manner. For example, the memory system 110 may receive, at a first time, a first read command 215 for a first set of data of a first sequential stream. The memory system 110 may store the first set of data in a first cache 220, and may output the first set of data to the host system 105 in accordance with the first read command. The memory system 110 may receive, at a second time after the first time, a second read command 215 for a second set of data of a second sequential stream. The memory system 110 may store the second set of data in a second cache 220, and may output the second set of data to the host system 105 in accordance with the second read command (e.g., without emptying the first cache 220). The memory system 110 may receive, at a third time after the second time, a third read command 215 for a third set of data of the first sequential stream. The memory system 110 may store the third set of data in the first cache 220, and may output the third set of data to the host system 105 in accordance with the third read command (e.g., without emptying the second cache 220).

In some examples (e.g., as illustrated with reference to the state entry 210-a), if a read command 215-a does not satisfy the threshold LBA 235-a (e.g., if all LBAs indicated by the read command 215-a are less than the threshold LBA 235-a), the memory system 110 may not update the window size 250-a of the pre-read window 225-a. In some examples (e.g., as illustrated with reference to the state entry 210-b), if a read command 215-b satisfies the threshold LBA 235-b (e.g., if one or more LBAs indicated by the read command 215-b are equal to or greater than the threshold LBA 235-b), the memory system 110 may update the window size 250-b of the pre-read window 225-b.

For example, the memory system 110 may set the window size 250-b to two times a previous window size 250-b of the pre-read window 225-b. That is, for a first pre-read request, a pre-read handler of the memory system 110 may request a quantity of LBAs equal to two times a chunk size of a first read command 215 to be loaded into the pre-read window 225. If the first read command 215 satisfies the threshold LBA 235, for a second pre-read request, the memory system 110 may request a quantity of LBAs equal to four times a chunk size of a first read command 215 to be loaded into the pre-read window 225. In some examples, the memory system 110 may double the window size 250 of the pre-read window 225 each time a read command 215 in the corresponding cache 220 satisfies the threshold LBA 235 (e.g., up to a threshold window size, which may be set by firmware of the memory system 110, such as a memory system controller 115, based on resources of local memory 120 of the memory system 110, such as a RAM resource).

In some examples, a memory system 110 may receive a read command 215 associated with LBAs that do not fall within any caches 220 that are currently in use by the memory system 110 when the memory system does not have a state entry 210 in a reset state (e.g., with an empty cache 220 and all parameters set to 0). The memory system 110 may accordingly determine if any state entries 210 of the memory system 110 are associated with potential other sequential streams 205 (e.g., with a hit count that is less than a hit count threshold). If the memory system 110 determines that a state entry 210 of the memory system 110 is associated with a hit count that is less than the hit count threshold, the memory system 110 may empty the corresponding cache 220 and reset the state entry 210 (e.g., set all parameters associated with the state entry 210 to 0). The memory system 110 may store data in the corresponding cache 220 and set the parameters of the state entry 210 in accordance with the read command 215 as described herein.

In some examples, a memory system 110 may receive a read command 215 associated with LBAs that do not fall within any caches 220 that are currently in use by the memory system 110 and the state entries 210 of the memory system 110 may not be associated with potential sequential streams 205 (e.g., may have a hit count that satisfies the hit count threshold). In such examples, the memory system 110 may not reset any state entries 210 or empty any caches 220. The memory system 110 may increment a value of an exit counter (e.g., sequentialExitCnt) associated with resetting all state entries 210 of the memory system 110. The memory system 110 may additionally, or alternatively, increment the value of the exit counter in response to receiving a command that is not a read command (e.g., or a read command for data that is not part of a sequential stream 205). If the value of the exit counter exceeds a threshold (e.g., a conflict tolerate threshold), the memory system 110 may reset all states entries 210 (e.g., empty all caches 220 and set all parameters of the state entries 210 to 0).

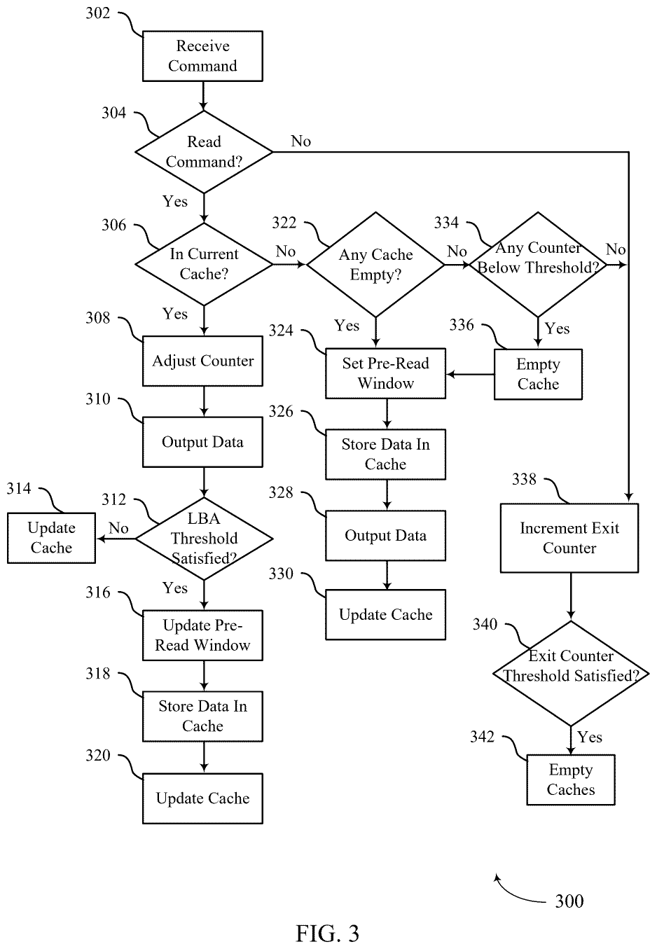

FIG. 3 shows an example of a process 300 that supports interleaved sequential read operations for memory systems in accordance with examples as disclosed herein. The process 300 may implement or may be implemented by aspects of a system 100 or a cache implementation 200. For example, aspects of the process 300 may be implemented by a memory system 110 (e.g., a memory system controller 115). Aspects of the process 300 may be implemented by processing circuitry, such as one or more controllers, among other components. Additionally, or alternatively, aspects of the process 300 may be implemented as instructions stored in one or more memories (e.g., firmware stored in one or more memories coupled with a memory system 110). For example, the instructions, when executed by one or more controllers (e.g., of a memory system controller 115), may cause the one or more controllers (or a device or a system) to perform the operations of the process 300.

At 302, a command may be received. For example, a memory system 110 may receive the command from a host system 105. The command may be received at a controller (e.g., a memory system controller 115) of the memory system 110. At 304, the memory system 110 may determine whether the command is a read command (e.g., a read command 215). If the command is a read command, at 306, the memory system 110 may determine whether the read command is requesting data that is stored in a currently active cache 220 (e.g., a non-empty cache) of a set of caches 220 of the memory system 110 (e.g., as one or more allocations of local memory 120).

If the read command is requesting data that is stored in a currently active cache 220, at 308, the memory system 110 may adjust a counter (e.g., a hit counter) associated with the currently active cache 220. At 310, the memory system 110 may output the requested data to the host system 105 (e.g., in accordance with a read command 215).

At 312, the memory system 110 may determine whether the read command satisfies an LBA threshold (e.g., a threshold LBA 235) associated with the currently active cache 220. If the read command does not satisfy the LBA threshold, at 314, the memory system 110 may update the cache 220 (e.g., update a state entry 210, update a start LBA 230, a threshold LBA 235, and/or a cache size 245 of the cache 220). If the read command satisfies the LBA threshold (e.g., if at least one LBA of the read command is greater than or equal to the threshold LBA 235), at 316, the memory system 110 may update a pre-read window 225 associated with the cache 220 (e.g., a window of LBAs of data that are ready to be read into the cache 220). For example, the memory system 110 may increase (e.g., double) a window size 250 of the pre-read window 225. At 318, the memory system 110 may store data (e.g., data from the pre-read window 225) in the cache 220 (e.g., by sending a pre-read request, to one or more memory devices 130). At 320, the memory system 110 may update the cache 220 (e.g., update a start LBA 230, threshold LBA 235, and/or cache size 245 of the cache 220), and, in some examples, may return to 302 (e.g., to receive another read command).

If, at 306, the memory system 110 determines that the read command is requesting data that is not stored in a currently active cache 220, at 322, the memory system 110 may determine whether a cache 220 (e.g., a pre-read entry, a state entry 210) of the memory system 110 is empty (e.g., in a reset state). If a cache 220 is empty, at 324 the memory system 110 may initialize the cache 220 by setting a start LBA 230, a cache size 245, and threshold LBA 235 of the cache 220. At 324, the memory system 110 may set a pre-read window 225 associated with the cache 220 (e.g., a window of LBAs of data that are ready to be read into the cache 220). At 326, the memory system 110 may store data in the cache 220. At 328, the memory system 110 may output the data to the host system 105 (e.g., in accordance with the read command). At 330, the memory system 110 may update the cache 220 (e.g., update a start LBA 230, threshold LBA 235, and/or cache size 245 of the cache 220), and, in some examples, may return to 302 (e.g., to receive another read command).

If, at 322, the memory system 110 determines that a cache 220 is not empty (e.g., if all caches of the memory system 110 currently store data), at 334, the memory system 110 may determine whether a hit counter associated with any caches 220 of the memory system 110 is below a threshold hit count. For example, the memory system 110 may determine if a cache 220 is associated with a potential sequential read (e.g., a potential sequential stream 205). If a hit counter of a cache 220 of the memory system 110 is below the threshold hit count, at 336, the memory system 110 may empty the cache 220 (e.g., reset the corresponding state entry 210) and may perform the operations of 324 through 330 to initialize the cache 220 and pre-read window 225 and output the data to the host system 105 in accordance with the read command.

If the command of 302 is not a read command and/or if the read command is requesting data that is not stored in a currently active cache 220, if all caches 220 of the memory system 110 currently store data, and if no hit counters of caches 220 of the memory system 110 are below the threshold hit count, at 338, the memory system 110 may increment an exit counter. At 340, the memory system 110 may determine whether the exit counter satisfies an exit threshold. If the exit counter satisfies the exit threshold, at 342, the memory system 110 may empty all caches 220 of the memory system 110 (e.g., reset all state entries 210).

In some implementations in accordance with the process 300, operations may occur in a different order than the example order shown and, in some examples, may be performed by one or more different devices other than those shown as examples. Some operations also may be omitted from the process 300, and other operations may be added to the process 300. Further, although some operations or signaling may be shown to occur at different times for discussion purposes, these operations may actually occur at the same time.

Thus, in accordance with these and other examples, a memory system 110 may be configured to store data in multiple caches 220, each associated with a respective sequential stream 205. Each cache 220 may be associated with a pre-read window 225 associated with data that is ready to be read into the cache 220, and the memory system 110 may increase a window size 250 if an LBA of a read command 215 satisfies a threshold LBA 235. In some examples, in response to receiving a read command 215 associated with an LBA that is outside of a currently active cache 220, the memory system 110 may store data in a new cache 220 without emptying the currently active cache 220. A memory system 110 may accordingly maintain multiple caches 220 corresponding to multiple concurrent sequential streams 205, which may decrease processing or latency times, improve response times, or otherwise improve user experience, among other benefits.

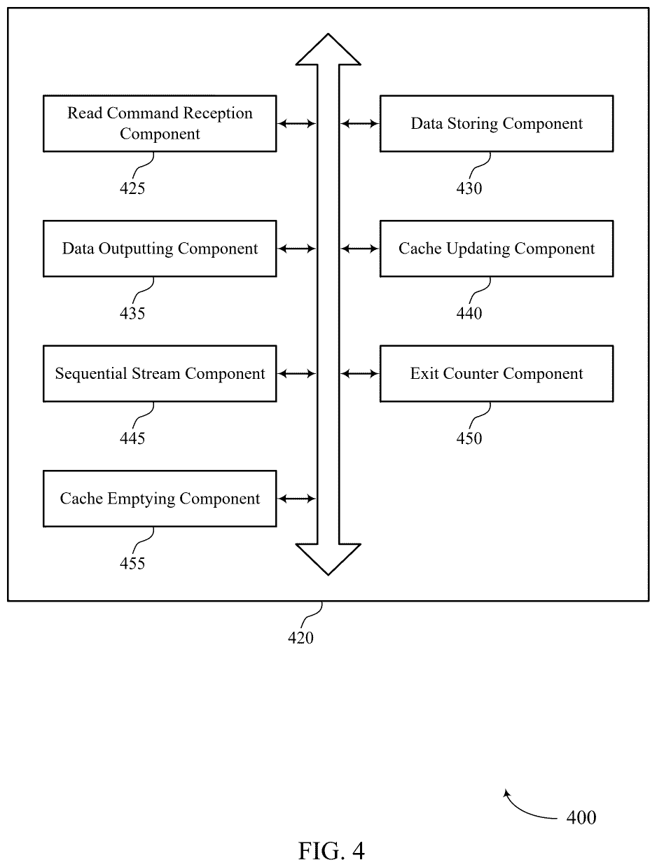

FIG. 4 shows a block diagram 400 of a memory system 420 that supports interleaved sequential read operations for memory systems in accordance with examples as disclosed herein. The memory system 420 may be an example of aspects of a memory system as described with reference to FIGS. 1 through 3. The memory system 420, or various components thereof, may be an example of means for performing various aspects of interleaved sequential read operations for memory systems as described herein. For example, the memory system 420 may include a read command reception component 425, a data storing component 430, a data outputting component 435, a cache updating component 440, a sequential stream component 445, an exit counter component 450, a cache emptying component 455, or any combination thereof. Each of these components, or components of subcomponents thereof (e.g., one or more processors, one or more memories), may communicate, directly or indirectly, with one another (e.g., via one or more buses).

The read command reception component 425 may be configured as or otherwise support a means for receiving one or more first read commands associated with a first data stream. The data storing component 430 may be configured as or otherwise support a means for storing, in response to receiving the one or more first read commands, first data associated with the first data stream in a first cache of the memory system. The data outputting component 435 may be configured as or otherwise support a means for outputting, from the memory system, the first data from the first cache in accordance with the one or more first read commands. In some examples, the read command reception component 425 may be configured as or otherwise support a means for receiving one or more second read commands associated with a second data stream. In some examples, the data storing component 430 may be configured as or otherwise support a means for storing, in response to receiving the one or more second read commands, second data associated with the second data stream in a second cache of the memory system while the first data is stored in the first cache the first cache. In some examples, the data outputting component 435 may be configured as or otherwise support a means for outputting, from the memory system, second data from the second cache in accordance with the one or more second read commands.

In some examples, the data storing component 430 may be configured as or otherwise support a means for transferring, in response to at least one of the one or more first read commands, the first data from one or more memory devices of the memory system to the first cache, where storing the first data in the first cache is in accordance with transferring the first data. In some examples, the data storing component 430 may be configured as or otherwise support a means for transferring, in response to at least one of the one or more second read commands, the second data from the one or more memory devices of the memory system to the second cache, where storing the second data in the second cache is in accordance with transferring the second data.

In some examples, the read command reception component 425 may be configured as or otherwise support a means for receiving, at a first time, at least one first read command of the one or more first read commands. In some examples, the data storing component 430 may be configured as or otherwise support a means for storing, in response to receiving the at least one first read command, a first portion of the first data in the first cache. In some examples, the read command reception component 425 may be configured as or otherwise support a means for receiving, at a second time after the first time, at least one second read command of the one or more second read commands. In some examples, the data storing component 430 may be configured as or otherwise support a means for storing, in response to receiving the at least one second read command, a portion of the second data in the second cache. In some examples, the read command reception component 425 may be configured as or otherwise support a means for receiving, at a third time after the second time, at least one additional first read command of the one or more first read commands. In some examples, the data storing component 430 may be configured as or otherwise support a means for storing, in response to receiving the at least one additional first read command, a second portion of the first data in the first cache.

In some examples, the first cache is associated with a pre-read window, and the cache updating component 440 may be configured as or otherwise support a means for increasing a size of the pre-read window in response to a logical block address associated with the one or more first read commands satisfying a threshold logical block address.

In some examples, the cache updating component 440 may be configured as or otherwise support a means for updating an initial logical block address associated with the first cache, a size of the first cache, or both in response to receiving at least one of the one or more first read commands.

In some examples, the sequential stream component 445 may be configured as or otherwise support a means for updating a value of a first counter associated with the first cache in response to receiving the one or more first read commands.

In some examples, the read command reception component 425 may be configured as or otherwise support a means for receiving one or more third read commands associated with a third data stream. In some examples, the cache emptying component 455 may be configured as or otherwise support a means for emptying, in response to receiving the one or more third read commands, the first data from the first cache in response to the first counter associated with the first cache being less than a threshold. In some examples, the data storing component 430 may be configured as or otherwise support a means for storing, in response to receiving the one or more third read commands, third data associated with the third data stream in the first cache of the memory system.

In some examples, the read command reception component 425 may be configured as or otherwise support a means for receiving one or more third read commands associated with a third data stream. In some examples, the exit counter component 450 may be configured as or otherwise support a means for incrementing, in response to receiving the one or more third read commands, an exit counter in accordance with the first counter associated with the first cache and a second counter associated with the second cache satisfying a threshold.

In some examples, the read command reception component 425 may be configured as or otherwise support a means for receiving one or more third commands that are different from read commands. In some examples, the exit counter component 450 may be configured as or otherwise support a means for incrementing, in response to receiving the one or more third commands, an exit counter.

In some examples, the cache emptying component 455 may be configured as or otherwise support a means for emptying the first cache and the second cache in accordance with an exit counter satisfying a threshold.

In some examples, the sequential stream component 445 may be configured as or otherwise support a means for determining, at the memory system, that both the first data stream and the second data stream are sequential streams. In some examples, the data storing component 430 may be configured as or otherwise support a means for allocating the first cache to the first data stream and the second cache to the second data stream in response to the determining.

In some examples, the data storing component 430 may be configured as or otherwise support a means for allocating the first cache to the first data stream in response to an indication associated with the one or more first read commands indicating that the first data stream is a first sequential data stream. In some examples, the data storing component 430 may be configured as or otherwise support a means for allocating the second cache to the second data stream in response to an indication associated with the one or more second read commands indicating that the first data stream is a first sequential data stream.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

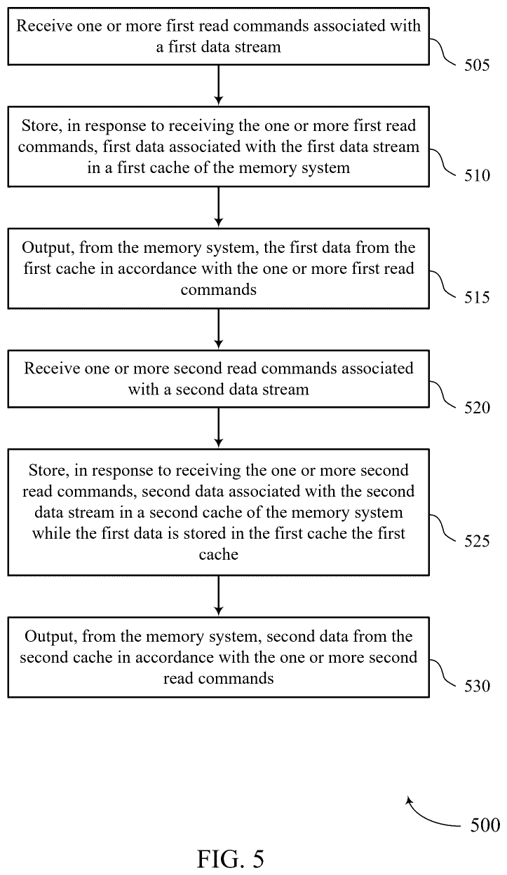

FIG. 5 shows a flowchart illustrating a process 500 that supports interleaved sequential read operations for memory systems in accordance with examples as disclosed herein. The operations of process 500 may be implemented by a memory system or its components as described herein. For example, the operations of process 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

Aspects of the process 500 may be implemented by one or more controllers, among other components. Additionally, or alternatively, aspects of the process 500 may be implemented as instructions stored in one or more memories (e.g., firmware stored in one or more memories coupled with a memory system 110). For example, the instructions, when executed by one or more controllers (e.g., a memory system controller 115, one or more local controllers 135, or a combination thereof), may cause the one or more controllers (or a device or a system) to perform the operations of the process 500.

At 505, the process may include receiving one or more first read commands associated with a first data stream. In some examples, aspects of the operations of 505 may be performed by a read command reception component 425 as described with reference to FIG. 4.

At 510, the process may include storing, in response to receiving the one or more first read commands, first data associated with the first data stream in a first cache of the memory system. In some examples, aspects of the operations of 510 may be performed by a data storing component 430 as described with reference to FIG. 4.

At 515, the process may include outputting, from the memory system, the first data from the first cache in accordance with the one or more first read commands. In some examples, aspects of the operations of 515 may be performed by a data outputting component 435 as described with reference to FIG. 4.

At 520, the process may include receiving one or more second read commands associated with a second data stream. In some examples, aspects of the operations of 520 may be performed by a read command reception component 425 as described with reference to FIG. 4.

At 525, the process may include storing, in response to receiving the one or more second read commands, second data associated with the second data stream in a second cache of the memory system while the first data is stored in the first cache the first cache. In some examples, aspects of the operations of 525 may be performed by a data storing component 430 as described with reference to FIG. 4.

At 530, the process may include outputting, from the memory system, second data from the second cache in accordance with the one or more second read commands. In some examples, aspects of the operations of 530 may be performed by a data outputting component 435 as described with reference to FIG. 4.

In some examples, an apparatus as described herein may perform a method or methods, such as the process 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving one or more first read commands associated with a first data stream; storing, in response to receiving the one or more first read commands, first data associated with the first data stream in a first cache of the memory system; outputting, from the memory system, the first data from the first cache in accordance with the one or more first read commands; receiving one or more second read commands associated with a second data stream; storing, in response to receiving the one or more second read commands, second data associated with the second data stream in a second cache of the memory system while the first data is stored in the first cache the first cache; and outputting, from the memory system, second data from the second cache in accordance with the one or more second read commands.
Aspect 2: The method, apparatus, or non-transitory computer-readable medium of aspect 1, further including operations, features, circuitry, logic, means, or instructions, or any combination thereof for transferring, in response to at least one of the one or more first read commands, the first data from one or more memory devices of the memory system to the first cache, where storing the first data in the first cache is in accordance with transferring the first data and transferring, in response to at least one of the one or more second read commands, the second data from the one or more memory devices of the memory system to the second cache, where storing the second data in the second cache is in accordance with transferring the second data.
Aspect 3: The method, apparatus, or non-transitory computer-readable medium of any of aspects 1 through 2, further including operations, features, circuitry, logic, means, or instructions, or any combination thereof for receiving, at a first time, at least one first read command of the one or more first read commands; storing, in response to receiving the at least one first read command, a first portion of the first data in the first cache; receiving, at a second time after the first time, at least one second read command of the one or more second read commands; storing, in response to receiving the at least one second read command, a portion of the second data in the second cache; receiving, at a third time after the second time, at least one additional first read command of the one or more first read commands; and storing, in response to receiving the at least one additional first read command, a second portion of the first data in the first cache.
Aspect 4: The method, apparatus, or non-transitory computer-readable medium of any of aspects 1 through 3, where the first cache is associated with a pre-read window and the method, apparatuses, and non-transitory computer-readable medium further includes operations, features, circuitry, logic, means, or instructions, or any combination thereof for increasing a size of the pre-read window in response to a logical block address associated with the one or more first read commands satisfying a threshold logical block address.
Aspect 5: The method, apparatus, or non-transitory computer-readable medium of any of aspects 1 through 4, further including operations, features, circuitry, logic, means, or instructions, or any combination thereof for updating an initial logical block address associated with the first cache, a size of the first cache, or both in response to receiving at least one of the one or more first read commands.
Aspect 6: The method, apparatus, or non-transitory computer-readable medium of any of aspects 1 through 5, further including operations, features, circuitry, logic, means, or instructions, or any combination thereof for updating a value of a first counter associated with the first cache in response to receiving the one or more first read commands.
Aspect 7: The method, apparatus, or non-transitory computer-readable medium of aspect 6, further including operations, features, circuitry, logic, means, or instructions, or any combination thereof for receiving one or more third read commands associated with a third data stream; emptying, in response to receiving the one or more third read commands, the first data from the first cache in response to the first counter associated with the first cache being less than a threshold; and storing, in response to receiving the one or more third read commands, third data associated with the third data stream in the first cache of the memory system.
Aspect 8: The method, apparatus, or non-transitory computer-readable medium of any of aspects 6 through 7, further including operations, features, circuitry, logic, means, or instructions, or any combination thereof for receiving one or more third read commands associated with a third data stream and incrementing, in response to receiving the one or more third read commands, an exit counter in accordance with the first counter associated with the first cache and a second counter associated with the second cache satisfying a threshold.
Aspect 9: The method, apparatus, or non-transitory computer-readable medium of any of aspects 1 through 8, further including operations, features, circuitry, logic, means, or instructions, or any combination thereof for receiving one or more third commands that are different from read commands and incrementing, in response to receiving the one or more third commands, an exit counter.
Aspect 10: The method, apparatus, or non-transitory computer-readable medium of any of aspects 1 through 9, further including operations, features, circuitry, logic, means, or instructions, or any combination thereof for emptying the first cache and the second cache in accordance with an exit counter satisfying a threshold.
Aspect 11: The method, apparatus, or non-transitory computer-readable medium of any of aspects 1 through 10, further including operations, features, circuitry, logic, means, or instructions, or any combination thereof for determining, at the memory system, that both the first data stream and the second data stream are sequential streams and allocating the first cache to the first data stream and the second cache to the second data stream in response to the determining.
Aspect 12: The method, apparatus, or non-transitory computer-readable medium of aspect 11, further including operations, features, circuitry, logic, means, or instructions, or any combination thereof for allocating the first cache to the first data stream in response to an indication associated with the one or more first read commands indicating that the first data stream is a first sequential data stream and allocating the second cache to the second data stream in response to an indication associated with the one or more second read commands indicating that the first data stream is a first sequential data stream.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive one or more first read commands associated with a first data stream;
store, in response to receiving the one or more first read commands, first data associated with the first data stream in a first cache of the memory system;
output, from the memory system, the first data from the first cache in accordance with the one or more first read commands;
receive one or more second read commands associated with a second data stream;
store, in response to receiving the one or more second read commands, second data associated with the second data stream in a second cache of the memory system while the first data is stored in the first cache the first cache; and
output, from the memory system, second data from the second cache in accordance with the one or more second read commands.

2. The memory system of claim 1, wherein the processing circuitry is further configured to cause the memory system to:
transfer, in response to at least one of the one or more first read commands, the first data from one or more memory devices of the memory system to the first cache, wherein storing the first data in the first cache is in accordance with transferring the first data; and
transfer, in response to at least one of the one or more second read commands, the second data from the one or more memory devices of the memory system to the second cache, wherein storing the second data in the second cache is in accordance with transferring the second data.

3. The memory system of claim 1, wherein the processing circuitry is further configured to cause the memory system to:
receive, at a first time, at least one first read command of the one or more first read commands;
store, in response to receiving the at least one first read command, a first portion of the first data in the first cache;
receive, at a second time after the first time, at least one second read command of the one or more second read commands;
store, in response to receiving the at least one second read command, a portion of the second data in the second cache;
receive, at a third time after the second time, at least one additional first read command of the one or more first read commands; and
store, in response to receiving the at least one additional first read command, a second portion of the first data in the first cache.

4. The memory system of claim 1, wherein the first cache is associated with a pre-read window, and wherein the processing circuitry is further configured to cause the memory system to:
increase a size of the pre-read window in response to a logical block address associated with the one or more first read commands satisfying a threshold logical block address.

5. The memory system of claim 1, wherein the processing circuitry is further configured to cause the memory system to:
update an initial logical block address associated with the first cache, a size of the first cache, or both in response to receiving at least one of the one or more first read commands.

6. The memory system of claim 1, wherein the processing circuitry is further configured to cause the memory system to:
update a value of a first counter associated with the first cache in response to receiving the one or more first read commands.

7. The memory system of claim 6, wherein the processing circuitry is further configured to cause the memory system to:
receive one or more third read commands associated with a third data stream;
empty, in response to receiving the one or more third read commands, the first data from the first cache in response to the first counter associated with the first cache being less than a threshold; and
store, in response to receiving the one or more third read commands, third data associated with the third data stream in the first cache of the memory system.

8. The memory system of claim 6, wherein the processing circuitry is further configured to cause the memory system to:
receive one or more third read commands associated with a third data stream; and
incrementing, in response to receive the one or more third read commands, an exit counter in accordance with the first counter associated with the first cache and a second counter associated with the second cache satisfying a threshold.

9. The memory system of claim 1, wherein the processing circuitry is further configured to cause the memory system to:
receive one or more third commands that are different from read commands; and
incrementing, in response to receive the one or more third commands, an exit counter.

10. The memory system of claim 1, wherein the processing circuitry is further configured to cause the memory system to:
empty the first cache and the second cache in accordance with an exit counter satisfying a threshold.

11. The memory system of claim 1, wherein the processing circuitry is further configured to cause the memory system to:
determine, at the memory system, that both the first data stream and the second data stream are sequential streams; and
allocate the first cache to the first data stream and the second cache to the second data stream in response to the determining.

12. The memory system of claim 11, wherein the processing circuitry is further configured to cause the memory system to:
allocate the first cache to the first data stream in response to an indication associated with the one or more first read commands indicating that the first data stream is a first sequential data stream; and
allocate the second cache to the second data stream in response to an indication associated with the one or more second read commands indicating that the first data stream is a first sequential data stream.

13. A non-transitory computer-readable medium storing code comprising instructions which, when executed by processing circuitry of a memory system, cause the memory system to:
receive one or more first read commands associated with a first data stream;
store, in response to receiving the one or more first read commands, first data associated with the first data stream in a first cache of the memory system;
output, from the memory system, the first data from the first cache in accordance with the one or more first read commands;
receive one or more second read commands associated with a second data stream;
store, in response to receiving the one or more second read commands, second data associated with the second data stream in a second cache of the memory system while the first data is stored in the first cache the first cache; and
output, from the memory system, second data from the second cache in accordance with the one or more second read commands.

14. The non-transitory computer-readable medium of claim 13, wherein the instructions, when executed by the processing circuitry of the memory system, further cause the memory system to:
transfer, in response to at least one of the one or more first read commands, the first data from one or more memory devices of the memory system to the first cache, wherein storing the first data in the first cache is in accordance with transferring the first data; and
transfer, in response to at least one of the one or more second read commands, the second data from the one or more memory devices of the memory system to the second cache, wherein storing the second data in the second cache is in accordance with transferring the second data.

15. The non-transitory computer-readable medium of claim 13, wherein the instructions, when executed by the processing circuitry of the memory system, further cause the memory system to:
receive, at a first time, at least one first read command of the one or more first read commands;
store, in response to receiving the at least one first read command, a first portion of the first data in the first cache;
receive, at a second time after the first time, at least one second read command of the one or more second read commands;
store, in response to receiving the at least one second read command, a portion of the second data in the second cache;
receive, at a third time after the second time, at least one additional first read command of the one or more first read commands; and
store, in response to receiving the at least one additional first read command, a second portion of the first data in the first cache.

16. The non-transitory computer-readable medium of claim 13, wherein the first cache is associated with a pre-read window, and wherein the instructions, when executed by the processing circuitry of the memory system, further cause the memory system to:
increase a size of the pre-read window in response to a logical block address associated with the one or more first read commands satisfying a threshold logical block address.

17. The non-transitory computer-readable medium of claim 13, wherein the instructions, when executed by the processing circuitry of the memory system, further cause the memory system to:
update an initial logical block address associated with the first cache, a size of the first cache, or both in response to receiving at least one of the one or more first read commands.

18. The non-transitory computer-readable medium of claim 13, wherein the instructions, when executed by the processing circuitry of the memory system, further cause the memory system to:
update a value of a first counter associated with the first cache in response to receiving the one or more first read commands.

19. The non-transitory computer-readable medium of claim 18, wherein the instructions, when executed by the processing circuitry of the memory system, further cause the memory system to:
receive one or more third read commands associated with a third data stream;
empty, in response to receiving the one or more third read commands, the first data from the first cache in response to the first counter associated with the first cache being less than a threshold; and
store, in response to receiving the one or more third read commands, third data associated with the third data stream in the first cache of the memory system.

20. The non-transitory computer-readable medium of claim 18, wherein the instructions, when executed by the processing circuitry of the memory system, further cause the memory system to:
receive one or more third read commands associated with a third data stream; and
incrementing, in response to receive the one or more third read commands, an exit counter in accordance with the first counter associated with the first cache and a second counter associated with the second cache satisfying a threshold.

21. The non-transitory computer-readable medium of claim 13, wherein the instructions, when executed by the processing circuitry of the memory system, further cause the memory system to:
receive one or more third commands that are different from read commands; and
incrementing, in response to receive the one or more third commands, an exit counter.

22. The non-transitory computer-readable medium of claim 13, wherein the instructions, when executed by the processing circuitry of the memory system, further cause the memory system to:
empty the first cache and the second cache in accordance with an exit counter satisfying a threshold.

23. The non-transitory computer-readable medium of claim 13, wherein the instructions, when executed by the processing circuitry of the memory system, further cause the memory system to:
determine, at the memory system, that both the first data stream and the second data stream are sequential streams; and
allocate the first cache to the first data stream and the second cache to the second data stream in response to the determining.

24. The non-transitory computer-readable medium of claim 23, wherein the instructions, when executed by the processing circuitry of the memory system, further cause the memory system to:
allocate the first cache to the first data stream in response to an indication associated with the one or more first read commands indicating that the first data stream is a first sequential data stream; and
allocate the second cache to the second data stream in response to an indication associated with the one or more second read commands indicating that the first data stream is a first sequential data stream.

25. A method at a memory system, comprising:
receiving one or more first read commands associated with a first data stream;
storing, in response to receiving the one or more first read commands, first data associated with the first data stream in a first cache of the memory system;
outputting, from the memory system, the first data from the first cache in accordance with the one or more first read commands;
receiving one or more second read commands associated with a second data stream;
storing, in response to receiving the one or more second read commands, second data associated with the second data stream in a second cache of the memory system while the first data is stored in the first cache the first cache; and
outputting, from the memory system, second data from the second cache in accordance with the one or more second read commands.
